(19) United States
(12) Patent Application Publication
(10) Pub. No.: US 2017/0175994 A1
(43) Pub. Date: Jun. 22, 2017

(54) LIGHTING SYSTEM FOR DOORS

(71) Applicant: JELD-WEN, Inc., Klamath Falls, OR (US)

(72) Inventors: Roger Kowash, Klamath Falls, OR (US); James Cooper, Klamath Falls, OR (US); Randy Cox, Klamath Falls, OR (US); Mark E. Riechmann, Klamath Falls, OR (US)

(21) Appl. No.: 15/382,189

(22) Filed: Dec. 16, 2016

Related U.S. Application Data
(60) Provisional application No. 62/268,833, filed on Dec. 17, 2015.

(51) Int. Cl. F21V 33/00; H05B 33/08; F21V 21/096; A47B 96/02; F21S 8/02; E05B 17/10; E06B 7/28; G06K 7/10; H05B 37/02; F21S 9/02

(52) U.S. Cl. CPC F21V 33/006; H05B 37/0218; H05B 37/0227; H05B 33/0842; F21V 21/096; F21S 9/02; F21S 8/02; E05B 17/10; E06B 7/28; G06K 7/10366; A47B 96/02; F21Y 2115/10

(57) ABSTRACT

A lighted shelf assembly for a door arranged to provide illumination for a user to facilitate unlocking and opening a door in low-light conditions. The lighted shelf assembly includes an illumination module supported on or along an underside of the shelf assembly, the module arranged to direct illumination downwardly toward a door lock or knob. The assembly further includes a motion detector operable to detect the presence of a user within its activation field, the motion detector in communication with the illumination module and operable to activate the illumination module upon detection of the user.

### RELATED APPLICATION DATA

This application is a nonprovisional of and claims the benefit under 35 U.S.C. §119(e) of U.S. Provisional Patent Application No. 62/268,833, filed Dec. 17, 2015, the disclosure of which is incorporated by reference herein in its entirety.

### TECHNICAL FIELD

The field of this disclosure relates generally to doors, and in particular, to illumination systems for residential exterior doors.

### BACKGROUND

In some situations, such as at night or when lighting conditions are otherwise low, it may be difficult for a person to locate a doorknob or lockset to unlock a door without additional light. In some instances, porch lights or other sources of exterior lighting may be used to illuminate the entryway and provide sufficient ambient light to aid in locating the lockset on the door. However, this approach has certain disadvantages, such as: (a) a person has to remember to leave the porch light on before leaving the house; (b) the porch light remains on throughout the day/night until the person comes home; and (c) the porch light illuminates the porch or entryway that the person may want to keep unlit to avoid bringing attention to a package sitting on the porch.

Accordingly, the present inventors have identified a need for an improved illumination system for a door that provides sufficient light for aiding a person in unlocking the door, while also conserving power when illumination is not required. Additional aspects and advantages will be apparent from the following detailed description of preferred embodiments, which proceeds with reference to the accompanying drawings.

### BRIEF DESCRIPTION OF THE DRAWINGS

FIG. 1 is a front view of a door with a lighted shelf assembly according to one embodiment.

FIG. 2 is a bottom perspective view of a door with a lighted shelf assembly according to another embodiment.

FIG. 3 is a partially exploded view of a lighted shelf assembly in accordance with another embodiment.

FIG. 4 is an enlarged view of a portion of the lighted shelf assembly of FIG. 3, illustrating additional detail of a housing structure for an illumination module.

FIG. 5 is a view of another embodiment of a lighted shelf assembly.

FIG. 6 is a front view of a door with a lighted shelf assembly according to another embodiment.

### DETAILED DESCRIPTION OF EXAMPLE EMBODIMENTS

With reference to the drawings, this section describes particular embodiments of various lighted shelf assemblies for doors and their detailed construction and operation. Throughout the specification, reference to “one embodiment,” “an embodiment,” or “some embodiments” means that a particular described feature, structure, or characteristic may be included in at least one embodiment of the safety system. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

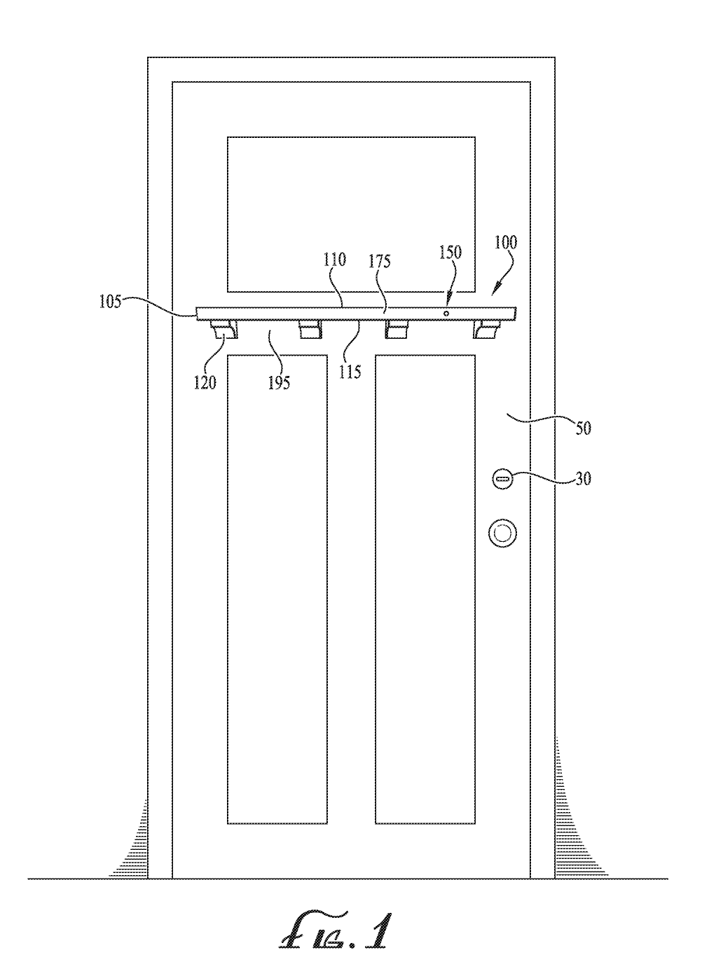

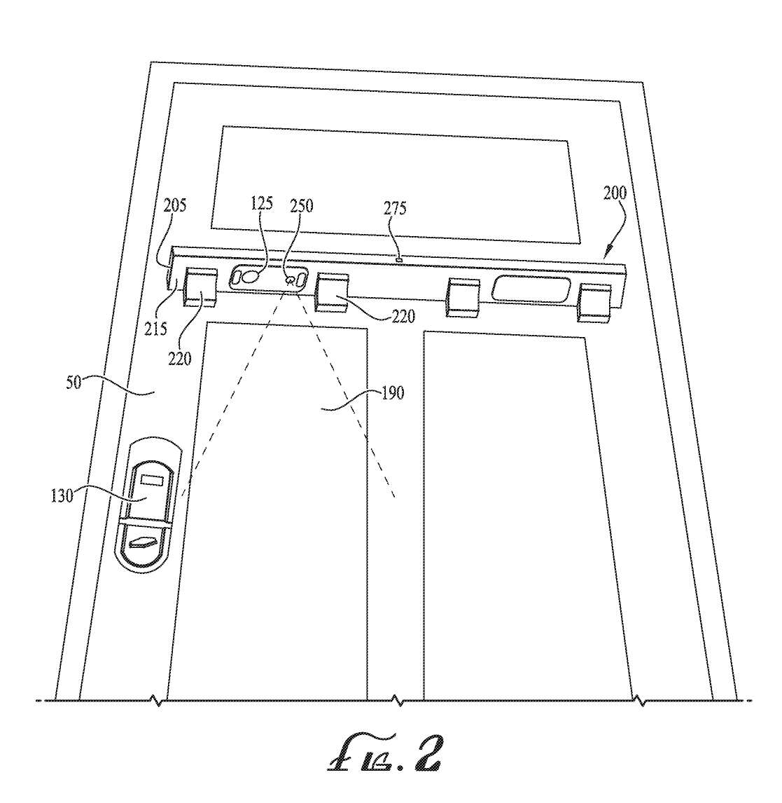

FIGS. 1-6 collectively illustrate various embodiments of a shelf assembly for a door, the shelf assembly operable to illuminate at least a portion of the door during poor lighting conditions. With particular reference to the embodiments illustrated in FIGS. 1 and 2, the shelf assembly 100, 200 includes one or more illumination source 125 integrated into or otherwise installed on the shelf assembly 100, 200. With particular reference to FIG. 2, in one embodiment, the illumination sources 125 may be positioned on or along a bottom surface 215 of the shelf assembly 200 and aimed downwardly to project light toward a lockset 130, or other component of the door 50, such as a door knob, handle, or latch. The shelf assembly 200 may include a sensor system 250 such as a motion sensor, proximity sensor, RFID system or any other suitable active or passive device, operable to detect the presence of a person within a specified range and/or activation field 190 of the sensor system 250.

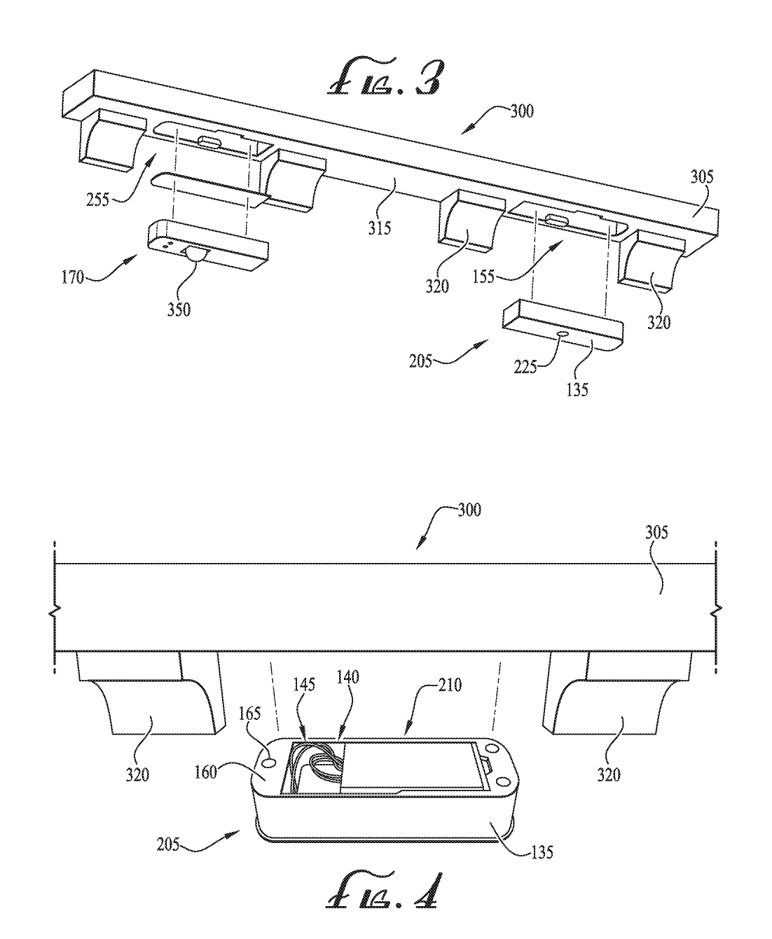

In an example operation, when the person enters the activation field 190 of the sensor system 250, (i.e., as a person nears the door 50) the sensor system 250 detects the presence of the person and sends a signal to the illumination module 205 (see FIG. 4) to trigger operation of the illumination sources 125. In response, the illumination sources 125 are activated and project light toward the lockset 130. With the lockset 130 illuminated, the person is able to quickly locate the lockset 130 and unlock the door 50 at night or during other poor lighting conditions. Once the person no longer activates the activation field 190, the illumination source 125 may automatically shut off, such as after a predetermined period of time has elapsed, to conserve power. Additional details of these and other embodiments relating to the shelf assembly and other components thereof are described in further detail below with reference to the figures.

FIG. 1 illustrates an embodiment of a shelf assembly 100 supported on or otherwise affixed (e.g., via mechanical, adhesive, or other suitable attachment mechanisms) to an exterior face of a door 50. With general reference to FIG. 1, the shelf assembly 100 includes an elongated base 105 with a top surface 110 and an opposite bottom surface 115. The shelf assembly 100 further includes a sensor 150 that may be mounted on a forward-facing surface 175 between the top and bottom surfaces 110, 115 of the base 105. When the shelf assembly 100 is mounted to the door 50, the shelf assembly 100 extends horizontally across a portion of the door 50 and is positioned above a lockset 30. For example, with reference to FIG. 1, the shelf assembly 100 may be mounted along the cross rail 195 of the door 50, but in other embodiments may be located elsewhere on the door 50. In some embodiments, the shelf assembly 100 is supported along the bottom surface 115 by one or more corbels 120. It should be understood that the shelf assembly 100 illustrated in the figures is only one example embodiment, and that in other embodiments, the base 105 may not be planar, but may include curvature or other aesthetic features not shown in the figures. As is further discussed in detail below with respect to the embodiments illustrated in FIGS. 2-6, the sensor 150 is operable to detect the presence of a person near the door 50 so that the shelf assembly 100 may illuminate the lockset 30 to facilitate entry under low-light conditions.

FIG. 2 illustrates an embodiment of a shelf assembly 200 supported on or otherwise affixed (e.g., via mechanical, adhesive, or other suitable attachment mechanisms) to an exterior face of a door 50. With particular reference to FIG. 2, the shelf assembly 200 includes one or more illumination sources 125 positioned along the bottom surface 215 of the base 205, such as between a pair of corbels 220. The illumination sources 125, when activated, provide light in a downward direction from the shelf assembly 100 toward the lockset 130. The illumination sources 125 may include any one of a variety of suitable devices or systems capable of providing light, such as light-emitting diodes (LEDs), light bulbs, or any other suitable light sources. The light generated from the illumination sources 125 may be of any wavelength in the visible spectrum.

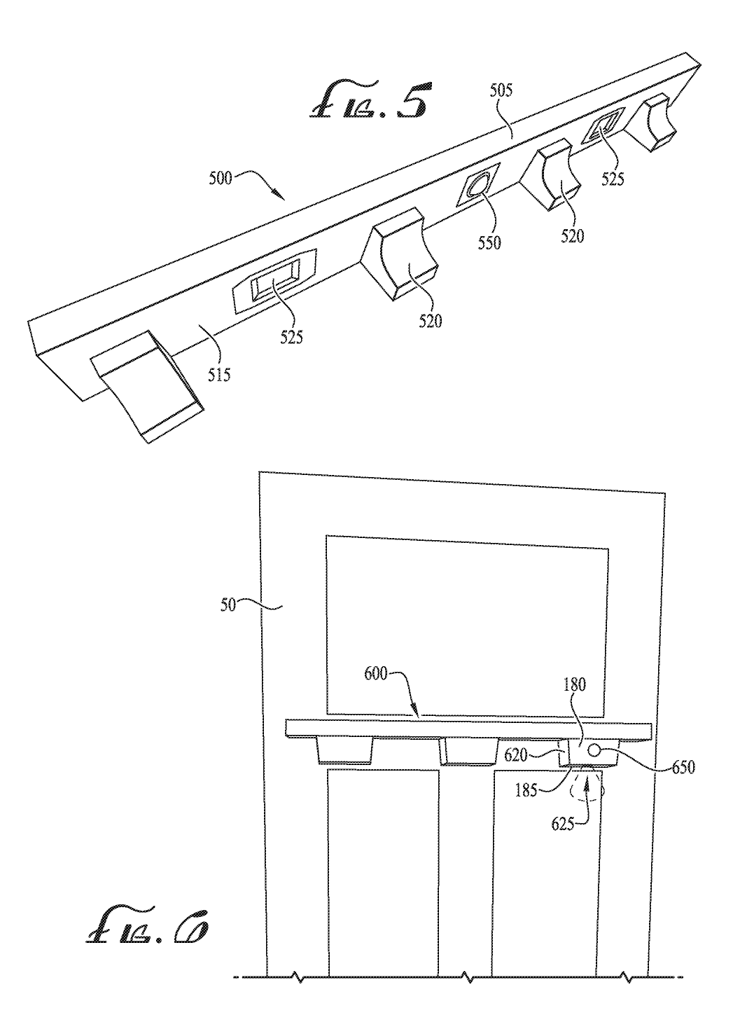

In some embodiments, the illumination sources (e.g., illumination source 125) may be housed within modular systems that may be embedded into or otherwise installed on an existing shelf assembly, thereby allowing any suitable shelf assembly to be retrofitted. FIGS. 3 and 4 illustrate an embodiment of a shelf assembly 300 with such modular illumination systems. With general reference to FIGS. 3 and 4, an illumination module 205 may include a housing structure 135 having an interior cavity 140 formed therein. Within the cavity 140, the housing structure 135 supports the illumination source 225, along with a battery unit 210 and electronics 145 (e.g., a processor and other electronic components) for powering and controlling the illumination source 225. With reference to FIG. 3, the shelf assembly 300 includes a recess 155 formed in the bottom surface 315 of the base 305, the recess 155 having dimensions suitable for receiving the illumination module 205. For shelf assemblies 300 having corbels 320, the recesses 155 may be formed between adjacent pairs of corbels 320 so that the corbels 320 do not interfere with the light provided by the illumination sources 225 (see also embodiment illustrated in FIG. 5).

During installation, the housing structures 135 are inserted into and received by the recess 155 of the shelf assembly 300, with the illumination sources 225 facing downwardly over the door lockset (such as locksets 30, 130 of FIGS. 1 and 2). In some embodiments, an adhesive substance, screws, or other suitable mechanical fastening mechanism may be used to secure the housing structure 135 within the recess 155.

In another embodiment, the housing structure 135 may be magnetically attached to the shelf assembly 300. For example, with reference to FIG. 4, a bottom surface 160 of the illumination module 205 may include one or more magnets 165 thereon. The magnets 165 may be press fit into bores (not shown) extending into the housing structure 135 or may be otherwise attached or adhered to the surface 160. The recess 155 may include a magnetic shim or plate (not shown) attached thereto to couple the magnets 165 with the shim/plate of the shelf assembly 100. In such arrangements, the magnetic coupling of the illumination module 205 may simplify removal and reattachment of the illumination module 205 as needed, such as for servicing, repair, and replacement of inoperable or malfunctioning components. In other embodiments, such as where the shelf assembly 300 may include or be formed from a magnetic material, the shim/plate may be omitted and the illumination module 205 may attach directly to the shelf assembly 100.

In still other embodiments, cavities or other chambers (not shown) may be machined directly into the shelf assembly 300, the cavities receiving the illumination sources 225 and electronics 145 therein. This arrangement may eliminate the need for using a separate illumination module 205 to install the illumination sources 225.

With reference to FIG. 3, the shelf assembly 300 also includes a sensor system 350 operable to detect the presence of a person located within an activation field or field-of-view (such as field 190 in FIG. 2) of the sensor system 350. The sensor system 350 may be carried or supported within a sensor module 170 (similar to the illumination module 205) and installed into a recess 255 formed along a bottom surface 315 of the base 305.

FIG. 5 illustrates another embodiment of a shelf assembly 500 having similar features and components as the shelf assembly 300 of FIG. 3 organized in a different arrangement. With particular reference to FIG. 5, the shelf assembly 500 includes a sensor system 550 positioned between an adjacent pair of corbels 520 and substantially centered along a bottom surface 515 of the base 505 to provide a sufficiently wide activation range or field-of-view to detect a person approaching the door 50. In some embodiments, the shelf assembly 500 further includes a pair of illumination sources 525 supported on either side of the sensor system 550 to provide additional illumination as desired.

As further discussed in detail below, any one of a variety of sensor devices or systems may be used in conjunction with the shelf assemblies 100, 200, 300, 500 described in the embodiments illustrated in FIGS. 1-5. For example, in one embodiment, the sensor system 150, 250, 350, 550 may be a motion detector (which may include optical sensors, microwave sensors, acoustic sensors, or other suitable sensors) operable to detect the presence of the person within its field-of-view 190. As described previously, the motion detector may be positioned on the bottom surface 115, 215, 315, 515 of the shelf assembly 100, 200, 300, 500, respectively, and may be centered between a pair of corbels 220 (as illustrated in FIG. 2) or between a pair of illumination sources 525 (as illustrated in FIG. 5). In other embodiments, such as illustrated in FIG. 1, the sensor system 150 (i.e., the motion detector) may be positioned on a front/forward surface 175 of the shelf assembly 100, with its field-of-view (not shown) directed in a forward or outward direction relative to the shelf assembly 100 to detect an approaching person. In such embodiments, the field-of-view of the sensor system 150 may be relatively limited to avoid inadvertent activation by people or animals that may be walking next to the door. Preferably, the location and position of the motion detector is such that neither the corbels 120 nor any other feature of the shelf assembly 100 impede the field-of-view of the motion detector.

In other embodiments, the sensor system 150, 250, 350, 550 may be a radio frequency identification (RFID) system operable to identify and track a tag that may be carried by the homeowner. For example, an RFID reader (not shown) may be embedded into or otherwise supported by the shelf assembly 100, and the person may carry an RFID tag, such as on a keychain or attached to the house key. When the person approaches the door 50, the RFID reader and the RFID tag communicate with one another to signal the presence of the person near the door 50. The RFID system may be any one of a variety of kinds of system, such as a passive-reader active-tag (PRAT) system, an active-reader passive-tag (ARPT) system, an active-reader active-tag (ARAT) system, or any other suitable RFID system.

As mentioned previously, the sensor system 150, 250, 350, 550 is in communication with the illumination sources 125, 225, 525, such that when the sensor system 150, 250, 350, 550 detects the presence of a person, the illumination sources 125, 225, 525 may be activated to illuminate the lockset 30, 130 on the door 50. With reference to FIG. 3-4, in some embodiments, the sensor system 350 may be hardwired directly with the electronics 145 of the illumination source 225, with the wiring running along an interior chamber or channel (not shown) of the shelf assembly 300. In other embodiments, the sensor system 350 may be in wireless communication with the electronics 145. For example, the sensor system 350 may include a transmitter (not shown) configured to transmit a signal when the sensor system 350 detects the presence of a person within its activation range or field-of-view. The electronics 145 may include a receiver (not shown) in communication with the transmitter of the sensor system 150, the receiver receiving the signal and operating the illumination source 225 in accordance with the signal.

In still other embodiments, the lockset may be an electronic lockset in communication with the sensor system. In one configuration, the sensor system detects the presence of the person and triggers the lockset to unlock the door for keyless entry. In another configuration, the sensor system may be integrated with the lockset, where the sensor system is an RFID system (or other suitable wireless system). The user may have an RFID tag (e.g., carried on a key or a key fob), where in response to detecting the presence of the RFID tag, the RFID system unlocks the lockset. In another embodiment, the lockset and sensor system may be in communication with a security system, where the security system may detect the presence of the person (e.g., via image recognition, via an RFID tag, or via other suitable identification systems or devices). When the security system detects the person, the security system may operate the lockset to unlock the door.

FIG. 6 illustrates another embodiment of a shelf assembly 600 in which the sensor system 650 and the illumination sources 625 are housed together and powered as an integrated unit. For example, with reference to FIG. 6, the sensor system 650 (illustrated as a motion detector) and the illumination source 625 may be housed together within one of the corbels 620. As illustrated in FIG. 6, the sensor system 650 may be positioned on a front portion 180 of the corbel 620, thereby providing the sensor system 650 with an unimpeded field-of-view to easily detect an approaching person. The illumination source 620 is arranged on an underside 185 of the corbel 620 to direct the illumination downwardly toward the lockset (e.g., lockset 130 of FIG. 2) when the sensor system 650 detects the person.

In some embodiments, the sensor system (and/or shelf assembly) may further include an ambient light sensor 275 (see FIG. 2) operable to detect the level of ambient light (e.g., from daylight or an external light source) near the door 50 to help conserve power when available ambient light is sufficient to illuminate the lockset 130. The following example proceeds with reference to the embodiment of the shelf assembly 200 of FIG. 2, but it should be understood that any of the embodiments described herein may incorporate an ambient light sensor. With reference to FIG. 2, the sensor system 250 detects the presence of the person and the ambient light sensor 275 determines that there is sufficient light for the person to easily locate the lockset 130 without requiring additional light (i.e., the ambient light sensor measures the light at a level exceeding a predetermined threshold level), then the sensor system 250 may not send a signal to operate the illuminate source 125, or the sensor electronics 145 (see FIG. 4) may disregard the signal and not activate the illumination source 125. In other embodiments, the measurements obtained by the ambient light sensor may be used to maintain the sensor system 250 in an inactive or standby mode until the level of ambient light is sufficiently low, i.e., the ambient light level falls below a threshold level, at which point, the sensor system 250 may be activated to ensure that the illumination sources 125 are activated only when needed, and to help conserve power for both the sensor system 250 and the illumination sources 125.

In other embodiments, the sensor system 250 (or other component of the lighted shelf assembly) may further including a timing mechanism operable to determine the time of day for selectively powering the sensor system 250 and/or illumination source 125 based on the time of day. For example, during daylight hours, the sensor system 250 and/or illumination source 125 may be in standby modes or otherwise not activated to conserve power since additional illumination may not be necessary. During nighttime or other low-light hours, the sensor system 250 and/or illumination source 125 may be in an active state. In some embodiments, the timing mechanism may be programmable to customize the system for individual users as desired.

It should be understood that although the embodiments have been described with reference to installing the illumination and sensor systems on a shelf assembly of a door, this particular arrangement is intended to illustrate one embodiment. In other embodiments, one or both of the illumination and sensor systems may be arranged on different components of the door. For example, the illumination system may include small LEDs supported on the sticking of the door, or may include LEDs or other illumination devices supported along the door jamb adjacent the lockset. In other embodiments, the illumination and sensor systems may be arranged in different configurations than those specifically described herein to achieve the advantages of the illustrated embodiments.

It is intended that subject matter disclosed in particular portions herein can be combined with the subject matter of one or more of other portions herein as long as such combinations are not mutually exclusive or inoperable. In addition, many variations, enhancements and modifications of the lighted shelf assembly concepts described herein are possible.

The terms and descriptions used above are set forth by way of illustration only and are not meant as limitations. Those skilled in the art will recognize that many variations can be made to the details of the above-described embodiments without departing from the underlying principles of the invention.

1. A lighted shelf assembly for a door, the shelf assembly comprising:
a shelf mountable to a door, the shelf including a top surface and an opposite bottom surface;
an illumination source carried by the shelf and arranged along the bottom surface thereof, the illumination source directing illumination downwardly from the bottom surface of the shelf;
a sensor system having an activation field adjacent the door, the sensor system operable to detect a presence of a person within the activation field, the sensor system generating an activation signal in response to detecting the presence of the person; and
a processor in communication with the illumination source and the sensor system, the processor operable to activate the illumination source in response to receiving the activation signal from the sensor system.

2. The lighted shelf assembly of claim 1, further comprising an illumination module mounted to the shelf, the illumination module including a housing structure having an interior cavity formed therein, the illumination source housed within the interior cavity of the housing structure.

3. The lighted shelf assembly of claim 2, wherein the shelf further includes a recessed portion formed along the bottom surface thereof, the recessed portion having dimensions suitable for receiving the illumination module therein.

4. The lighted shelf assembly of claim 2, wherein the sensor system and the processor are both housed within the interior cavity of the housing structure.

5. The lighted shelf assembly of claim 2, wherein one of the housing structure and the shelf further includes a magnet, and wherein the other of the housing structure and the shelf further includes a magnetic material, the magnet and magnetic material operable to magnetically attach the housing structure to the shelf.

6. The lighted shelf assembly of claim 1, further comprising an ambient light sensor in communication with the processor, wherein the ambient light sensor is operable to detect an ambient light level, and wherein the processor selectively activates the illumination source based in part on the ambient light level.

7. The lighted shelf assembly of claim 1, further comprising an ambient light sensor in communication with the processor, wherein the ambient light sensor is operable to detect an ambient light level, and wherein the processor selectively activate the sensor system based in part on the ambient light level.

8. The lighted shelf assembly of claim 1, further comprising an ambient light sensor in communication with the sensor system, wherein the ambient light sensor is operable to detect an ambient light level, compare the ambient light level to a threshold ambient light level, and activate the sensor system when the ambient light level is less than the threshold ambient light level.

9. The lighted shelf assembly of claim 1, wherein the sensor system is carried on the shelf.

10. The lighted shelf assembly of claim 1, wherein the sensor system further includes an RFID system.

11. A door including the lighted shelf assembly of claim 1, the door further including a lock system supported on the door underneath the lighted shelf assembly, wherein the illumination from the illumination source is directed toward the lock system.

12. A door with an illumination system comprising:
an illumination source carried by the door, the illumination source directing illumination toward a lockset carried by the door;
a sensor system carried by the door and having an activation field adjacent the door, the sensor system operable to detect a presence of a person within the activation field, the sensor system generating an activation signal in response to detecting the presence of the person; and
a processor carried by the door and in communication with the illumination source and the sensor system, the processor operable to activate the illumination source in response to receiving the activation signal from the sensor system.

13. The door of claim 12, further comprising an ambient light sensor in communication with the processor, wherein the ambient light sensor is operable to detect an ambient light level, and wherein the processor selectively activates the illumination source based in part on the detected ambient light level.

14. The door of claim 12, further comprising an ambient light sensor in communication with the processor, wherein the ambient light sensor is operable to detect an ambient light level, and wherein the processor selectively activates the sensor system based in part on the detected ambient light level.

15. The door of claim 12, further comprising an ambient light sensor in communication with the sensor system, wherein the ambient light sensor is operable to detect an ambient light level, compare the ambient light level to a threshold ambient light level, and activate the sensor system when the ambient light level is less than the threshold ambient light level.

16. The door of claim 12, further comprising a shelf attached to the door, the shelf housing the illumination source therein.

17. The door of claim 16, further comprising an illumination module, the illumination module including a housing structure having an interior cavity formed therein, the illumination source housed within the interior cavity of the housing structure, and wherein the shelf further includes a recessed portion formed along a bottom surface thereof, the recessed portion having dimensions suitable for receiving the illumination module therein.

18. The door of claim 17, wherein the sensor system and the processor are both housed within the interior cavity of the housing structure.

19. The door of claim 17, wherein one of the housing structure and the shelf further includes a magnet, and wherein the other of the housing structure and the shelf further includes a magnetic material, the magnet and the magnetic material operable to magnetically attach the housing structure to the shelf.

20. The door of claim 12, wherein the sensor system further includes an RFID system.
